(19) United States
(12) Patent Application Publication
(10) Pub. No.: US 2008/0281720 A1
(43) Pub. Date: Nov. 13, 2008

(54) METHOD AND APPARATUS OF INTERACTIVE BIDDING

(75) Inventor: David Hassan, Mundelein, IL (US)

Correspondence Address: BOYLE FREDRICKSON S.C., 840 North Plankinton Avenue, MILWAUKEE, WI, 53203, US

(73) Assignee: EVENTS. ORG, Chicago, IL (US)

(21) Appl. No.: 12/116,024

(22) Filed: May 6, 2008

Related U.S. Application Data
(60) Provisional application No. 60/916,350, filed on May 7, 2007.

(51) Int. Cl. G06Q 30/00

(52) U.S. Cl. 705/26

(57) ABSTRACT

A method and apparatus for automating an auction is provided that includes a secure server, at least one device for entering data, and software executing on both the server and the device. A participant is able to enter bidding information in each device. Bids from each participant are managed, the winning bidder is determined, and the current status of the auction is maintained. Each participant can individually receive the status of the items they bid on and the general auction status is also available for display. The auction status may be displayed at each device or optionally on a projection system. At the close of auction, the winning bids for each participant are compiled and listed for ease of payment.

### CROSS REFERENCE TO RELATED APPLICATION

This invention claims priority from Provisional Application No. 60/916,350 entitled Interactive Bidding—Method and Apparatus to Automate Auction Bidding filed May 7, 2007, the entirety of which is hereby incorporated by reference.

### BACKGROUND OF THE INVENTION

1. Field of the Invention

The present invention is directed generally to silent and live auction events, and more specifically to a method and apparatus for operating both live and silent auction events to increase bidding activity, improve ease of administration of the results, and improve the participant experience.

2. Discussion of the Prior Art

Silent auctions commonly deploy a standard method for collecting bids from the guests and participants, requiring guests to record a single bid on a bid sheet next to the item. Guests must then circulate around the room entering their bids on the bid sheet for each item upon which they are interested in bidding. Guests are further required to periodically return to each item upon which they wish to bid and monitor the status of the bidding, checking to see if they have been out-bid and determine whether they wish to place a higher bid. At the close of the auction, all of the bid sheets must be gathered, the winning bids recorded, and each bidder needs to receive a list of the items they won and the amount of the winning bids.

Live auctions dispense with the bidding slips and use a live auctioneer to encourage bidding among the guests and to solicit the winning bid for each item. However, similar to silent auctions, live auctions also require the winning bids to be manually recorded and a record to be provided to each bidder of the items they won and the amount of the winning bids.

These traditional methods of operating an auction are inefficient. The silent auction requires participants to continually monitor multiple bidding sheets throughout the room to check the status of items upon which they have bid. Requiring guests to continually monitor silent auction bids reduces the amount of time the guest is able to enjoy the event. And, at the close of the auction, each participant's winning bids must be compiled from the bidding slips in a silent auction, or from the record of the winning bids in a live auction, and often from both sources in a combined silent and live auction event.

In addition, silent and live auctions are often used as a means of find-raising. A fund-raising event may lose out on potential revenue if guests do not closely monitor their bids during a silent auction. An item may be sold to one guest for a price lower than a second guest may have been willing to pay if the second guest had observed that he was no longer the highest bidder.

Therefore, the field of operating silent and live auctions was in need of a system and method of operating an auction that improves the efficiency of the auction.

### SUMMARY OF INVENTION

The present invention overcomes the inefficiencies of existing methods of operating both silent and live auctions by automating many of the processes involved in operating an auction. A participant is able to enter all of their bids for each of the items in which they are interested at a single location. The current status of the auction is continually monitored and preferably displayed such that participants can conveniently monitor the status of their bids. At the close of auction, the winning bids for each of the participants are readily available.

According to a first embodiment of the invention, a method of automating an auction includes providing a secure server configured to manage the auction. At least one device to accept an input from a participant is also provided. The input may include but is not limited to an initial bid, a maximum bid, a unique user identification number, an optional user password, and an inquiry of the current status of the auction. At least one initial bid, along with a maximum bid corresponding to each of the initial bids, is accepted from each of the participants in the auction, and the participant assigns each pair of bids to an item in the auction. A winning bidder of each item is determined based on each of the initial bids and the corresponding maximum bid that is assigned to the item.

In an alternate embodiment of the invention, at least one participant provides one of the devices, and the server may be configured to interact with the participant-provided device. The participant-provided device may consist of at least one of the following items: a computer, a portable digital device, a mobile telephone, or any device that utilizes open web services.

The server manages the bidding between the participants. In one embodiment of the invention, the server manages concurrent bids from two or more of the participants. The concurrent bids may be on the same item or on multiple items. As still another aspect of the invention, the server manages multiple winning bids on a single item. This facilitates bidding on lots with multiple items or on find-a-need items. In yet another embodiment of the invention, the initial bid and the maximum bid may be the same bid. This facilitates auctions that do not wish to implement the maximum bid feature and, optionally, provides a default maximum bid when participants enter only an initial bid.

In yet another aspect of the invention, the current status of the auction is displayed. The current auction status is preferably displayed on each of the devices, on a projection system, or on both the devices and the projection system. The projection system may be, but is not limited to, a large screen television, a plasma television, or a projection device, displaying, for example, on a screen or a wall.

In another aspect of the invention, a personalized tracking list is maintained for each of the participants. The personalized tracking list is preferably accessible at each of the devices. It allows the participant to see all their bids and the status on one form, and be able to submit the bid amount and the maximum bids for any or all of the items that have been outbid and to submit the information in one request or submission.

In yet another aspect of the invention, the server accepts a maximum spending limit. The maximum spending limit compares the total amount of each of the participant's bids to this spending limit and prevents the server from automatically increasing the participant's bid on an item, based on the maximum bid for the item, when the maximum spending limit has been reached.

According to yet another aspect of the invention, the server can close a first group of items at different time than another group of items.

As still another aspect of the invention, a bidding form may be distributed to each of the participants. The initial and the maximum bids of the participants are entered onto the bidding forms. At least one trained user is provided who enters the bids from the participants into the device.

According to another embodiment of the invention, a method of automating an auction includes configuring and providing a secure server to manage the auction. At least one device is provided to accept an input from a participant. Each of the participants is assigned a unique bidder identifier. The method also accepts at least one initial bid, along with a maximum bid corresponding to each of the initial bids, on at least one item from each of the participants in the auction. A winning bidder of each item is determined based on each of the initial bids and the corresponding maximum bid that is assigned to the item.

According to still another aspect of the invention, each of the unique participant identifiers is a unique bidder identification number. Alternately, each of the unique participant identifiers can be linked to a barcode, REID, wireless phone number or magnetic card (or other newer technologies used for personal identification). Notably, in the preferred embodiments when a participant wishes to interact with the auction system, the participant need not provide a password or otherwise log in, they simply need their unique identification number.

Still another embodiment of the invention is an apparatus for automating an auction that includes a secure server and at least one device. The secure server is configured to manage the auction and each of the devices accepts bidding information. The apparatus further includes software that accepts at least one initial bid and a corresponding maximum on at least one item from each of the participants in the auction. The software stores each of the initial and corresponding maximum bids for each item and determines a winning bidder for each item based on each of the initial and the corresponding maximum bids that are assigned to the item.

In another aspect of the invention, the apparatus further includes a projection system. Preferably, the projection system displays one or more of the following items: a list of the most active bids, a list of the most recent bids, a list of the current bids, a list of the winning bids, a description of each of the items, a scrolling display of the active bids, a recognition of at least one of the donors of the items, and a recognition of at least one of the sponsors of the event.

In yet another embodiment of the invention, the device consists of at least one of the following items: a computer, a portable digital device, and a mobile telephone. Alternately, the device consists of any hardware that utilizes open web services.

These and other features and advantages of the invention will become apparent to those skilled in the art from the following detailed description and the accompanying drawings. It should be understood, however, that the detailed description and specific examples, while indicating preferred embodiments of the present invention, are given by way of illustration and not of limitation. Many changes and modifications may be made within the scope of the present invention without departing from the spirit thereof, and the invention includes all such modifications.

### BRIEF DESCRIPTION OF THE DRAWINGS

FIG. 1 illustrates an exemplary embodiment of the invention at an auction;

FIG. 2 is a schematic illustration of a participant at an auction event moderated according to a preferred embodiment, the participant using a hand-held bid entry device;

FIG. 3 is a flowchart of a preferred embodiment of the present invention; and

FIG. 4 is a flowchart illustrating how bidding is moderated according to a preferred embodiment of the invention.

### DETAILED DESCRIPTION OF THE PREFERRED EMBODIMENTS

The preferred embodiments are directed to a method and apparatus for operating both live and silent auction events. More specifically, the present invention automates many of the functions involved in running an auction, thereby improving the efficiency of the auction.

In a preferred embodiment, an auction system 25 includes a secure server 30 is provided that is configured to manage an auction 20. Additionally, at least one device 40 is provided that allows a participant 50, or optionally a trained user, to enter data relating to the auction 20. Each device 40 is configured to communicate with the server 30 through either a wired or a wireless connection. Software is also provided that interfaces the server 30 with each device 40 to efficiently run the auction 20.

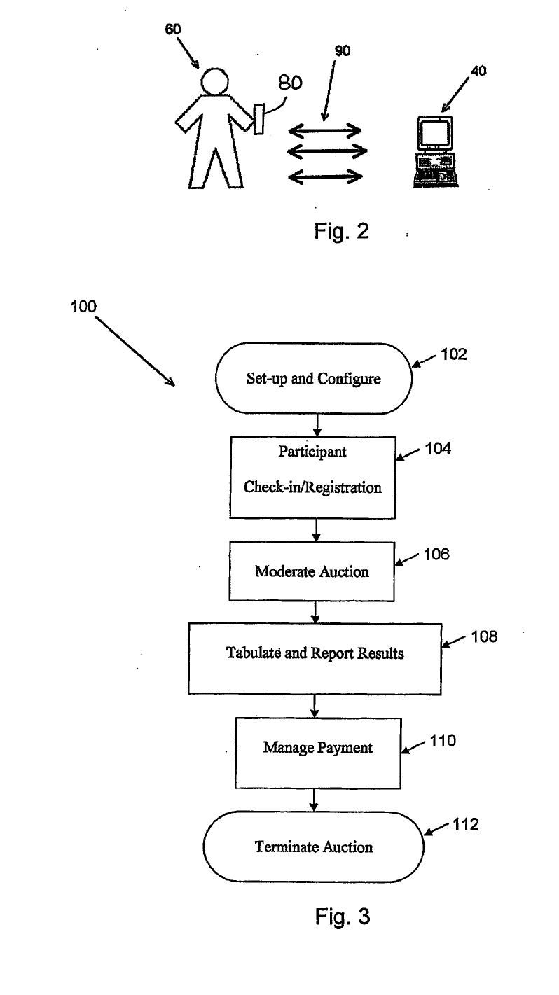

It is contemplated that each device 40 may be one of, or a combination of, a computer, a portable digital device (FIG. 2), or a mobile telephone. More specifically, the device 40 may be, but is not limited to, a desktop computer, a laptop computer, a notebook computer, a tablet computer, a handheld computer, a personal digital assistant, a mobile phone, or a smart phone. Another embodiment contemplates that the device 40 may be any hardware that utilizes open web services, allowing the device 40 to communicate with the server 30.

It is further contemplated, that a participant may provide the device 40 that the participant will use to enter data relating to the auction. In one embodiment, the software is downloaded to the device 40 provided by the participant such that the device 40 is able to communicate with the server 30. In another embodiment, the device 40 may access the server 30 through an internet connection. Additionally, any combination of the aforementioned devices 40 or options for communicating with the server 30 may be used without deviating from the scope of the invention.

Each participant 50 is assigned a unique identifier for use at the auction 20. Preferably, the identifier is a unique identification number for use at the auction 20. It is also contemplated that the identifier may be a barcode printed on an identification card for scanning, RFID signal for detecting, wireless phone number for interfacing, or a magnetic card for swiping. The user may use any of the options above, including entering the unique bidder number upon each interaction (registration, bid entry, etc.) with system 25. In a preferred embodiment, a first identification number is assigned at one thousand, and each subsequent identification number is assigned by incrementing the previous identification number by three numbers. Alternatively, at least a portion of each participant's 50 last name may be used in creating each identification number. If desired, a unique passcode may also be assigned to each participant 50.

Each participant may be identified by one of the devices 40 using the unique identifier assigned to the participant 50. In a preferred embodiment, each participant 50 is identified by the device 40 using the participant's identification number and, if provided, the participant's passcode. Alternatively, the participant 50 may logon using the bidder's name. Again, it is also contemplated that each participant may be identified by an optical scanner connected to the device that identifies the barcode issued to the participant.

The participant 50 enters bidding data using one of the devices 40. The participant 50 enters at least one item number and an initial bid and, optionally, a maximum bid for each item 60. The server will manage each of the participant's bids and will provide a personalized tracking list for each participant. The personalized tracking list is available at any device 40 and at the server 30. The tracking list contains the current status of each of the participant's bids and allows the participant to update each of the bids or to add additional bids.

In another embodiment, a trained user is provided to enhance the efficiency of the auction. The trained user provides forms to each of the participants 50. On the form, each participant 50 enters the participant's identification number, each item number on which the participant 50 wishes to bid, and the initial bid and the maximum bid that participant wishes to place on each item. The trained user then enters the information from the form into a device 40 or into the server 30. The trained user can provide each participant 50 with a personalized tracking list and can update each participant's bids as instructed by the participant 50.

The server will use each of the initial and maximum bids for each item to manage the auction. If a participant 50 enters a new bid for an item 60 in the auction, the software will compare the new initial bid and the new maximum bid to the current high bid on the item 60 and the corresponding maximum bid on the item 60. The software will continue incrementing the bids for the participant 50 entering the new bid and for the participant 50 that currently has the highest bid on the item until the maximum bid for one of the two participants is reached. The results of the bidding process will be displayed on each of the devices 40, and, if included, a projection system 70 to inform the participants of the current status of the auction 20. In addition, if the item 60 is a multiple item, each of the highest bids will be displayed for the item 60. The winning bid will be the highest bid on the item 60 when the item closes.

In a preferred embodiment, each participant 50 may also enter an auction spending limit. This auction spending limit presents a maximum dollar amount for the total of the participant's current bids. As the server increments a participant's bid, the total amount of each of the participant's bids that are presently the highest bid on an item 60 are added together. If this total amount reaches the auction 20 spending limit, the server will stop incrementing a participant's bid on an item 60 even if the maximum bid was not reached. In a preferred embodiment, in the event that the user is outbid or does not win a particular item, the amount of that bid is subtracted from the sum of that participant's running total of bids. This feature will help a participant from spending more than a predetermined dollar amount during the course of the auction 20.

Turning to FIG. 2, a participant 60 at the auction 20 preferably uses a hand-held device 80 for entering bids, as well as other auction related operations (e.g., registration, etc.). When the participant wishes to enter a bid, the participant keys in a bid on device 80 which communicates with server 30 via a communication link 90. Communication link 90 may be a wireless connection, or a physical connection such as a USB cable adapted to communicate between the hand-held device 80 and server 30. Alternatively, communication link 90 may be the internet. Hand-held device 80 may also be equipped with the ability to receive information such as notifications when the participant's maximum bid has been exceeded. In this way, the participant's enjoyment of the auction is improved by not requiring that the participant to continuously monitor the status of an auction item upon which they have bid, while also providing the additional benefit of maximizing the dollars generated by the auction item by giving the participants an opportunity to bid again in the event that they are outbid.

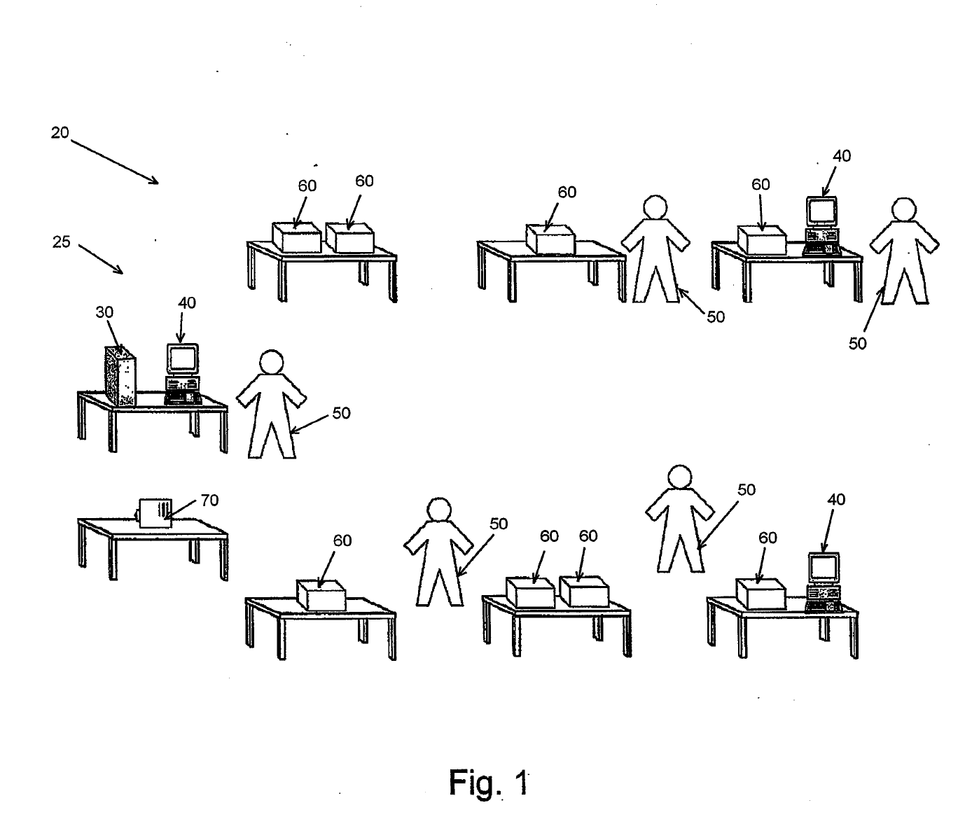

As noted previously, to further facilitate the transparency of a progressing auction, an auction status projection system 70 (FIG. 1) may be integrated with the auction management server 30. The auction status projection system 70 allows the current status of the auction to be easily viewed. For example, the information may be sent to a projector, a large screen television, or to any other means suitable for making the auction status readily viewable. The status information that is displayed may include, but is not limited to: a list of the most active bids, a list of the most recent bids, a list of the current bids, a list of the winning bids, a description of an item 60 in the auction, a scrolling display of the active bids, recognition of a donor of an item 60, recognition of a sponsor of the auction 20, or any combination thereof.

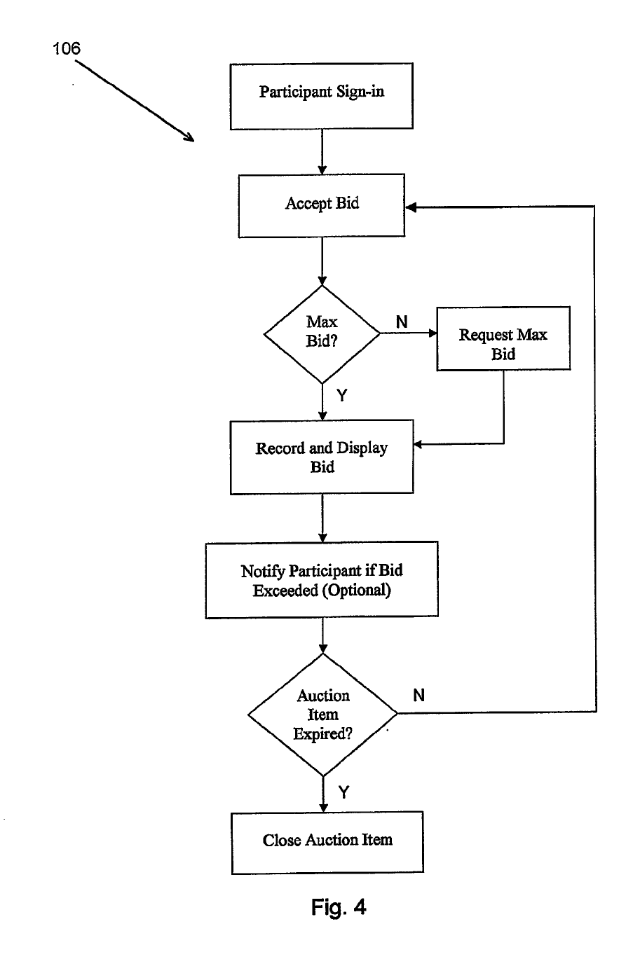

Referring next to FIG. 3, a method 100 of operating an auction according to a preferred embodiment includes setting up auction equipment in Block 102 including providing user input devices, a server, a communication link and appropriate software. Once setup is complete, the auction allows the moderator to facilitate participant check-in and registration at Block 104. This allows the participants to be assigned an appropriate identification number or code so they can be identified as they participate in the auction. Once the auction has begun, the system of the preferred embodiments allows the moderator to moderate the bidding in Block 106, further detailed below in connection with FIG. 4. Notably, each time the participant wishes to interact with system 25 (FIG. 1), the participant does not need to use a password or otherwise log in. Rather, the unique identification number provided to the participant (e.g., at registration) is all that is required. This facilitates rapid entry of bids and improves the auction experience for both the moderator as well as the participants.

Next, as moderation of the bidding progresses in Block 106, and individual items expire or come off auction, method 100 allows the preferred embodiment to tabulate and report results in Block 108. At this point, method 100 closes the transaction by obtaining payment from the participant. Payment may be facilitated via a direct request to the winning bidders, via a hand-held device, for example, or the winning bidder may be automatically charged using their credit card on-file, which the participant may provide at registration. The auction may then be terminated at Block 112.

Turning to FIG. 4, the moderate bidding Block 106 of FIG. 3 is described in further detail. Once participants are checked-in and registered, each participant can sign in at Block 120. Participants may remain signed-in or, if disconnected for whatever reason, may sign in each time he/she needs to interface with the system. At this point, auction 20 is prepared to accept bids in Block 122. Bids may be accepted via a hand-held device with an appropriate keypad, for instance, or user input devices may be provided at the auction location for access by the participants. Once update information is entered, Block 106 may employ bidding moderation software to ask whether the participant wants its bid to be its maximum bid in Block 124. If yes, the method enters and records the bid for communication and/or display to the other participants in Block 126. If the user enters a bid that is different than its maximum bid, the system requests the participant to enter a maximum bid in Block 128.

As the system of the preferred embodiments accepts bids, “bid status” including current high bids are preferably displayed for all the participants to see, with outbid participants preferably being notified, via their hand-held device that they have been outbid if such is the case (see Block 130). The method next determines whether time has expired with respect to an auction for any particular item in Block 132. If the auction has expired, the auction is closed in Block 134 and the winning bidder is notified. Preferably, the losing bidders are also notified that they did not win that particular auction item, giving them the opportunity to bid on other items in the alternative. If the auction associated with the item has not timed-out, the moderate bidding program 106 returns to Block 122 to accept further bids. The above described steps progress for each auction item until the open bidding for every item is complete, at which time the auction is ended in Block 132.

Although the best mode contemplated by the inventors of carrying out the present invention is disclosed above, practice of the present invention is not limited thereto. It will be manifest that various additions, modifications and rearrangements of the features of the present invention may be made without deviating from the spirit and scope of the underlying inventive concept.

I claim:

1. A method for automating an auction comprising the steps of:
providing a secure server configured to manage the auction;
accepting at least one initial bid from at least one of a plurality of participants wherein each of the initial bids is assigned to an item in the auction;
associating each participant with an identifier;
determining a winning bidder for each of the items in the auction based on the initial bids assigned to each of the items; and
automatically identifying the winning bidder using the identifier.

2. The method of claim 1 further comprising updating the status of at least one of the items before bidding for the item is closed and conveying the status to one or more of the participants.

3. The method of claim 2 wherein the current status of the auction is displayed on a projection system.

4. The method of claim 1 wherein the accepting step includes the participant interfacing with at least one device.

5. The method of claim 4 wherein the at least one device is a portable digital device provided by one of the participants.

6. The method of claim 4 further comprising the step of providing a personalized tracking list for each of the plurality of participants, and wherein the personalized tracking list is accessible on the device.

7. The method of claim 1 wherein the server can manage the input from two or more participants wherein the input includes concurrent bids.

8. The method of claim 1 wherein the server can manage multiple winning bids on individual items.

9. The method of claim 1 further comprising accepting a maximum bid corresponding to the initial bid.

10. The method of clam 9, wherein the initial and the corresponding maximum bids are the same bid.

11. The method for claim 9 wherein accepting the initial bid and the corresponding maximum bid from each of a plurality of participants further comprises the steps of:
distributing at least one form to each of the plurality of participants wherein each form accepts each of the initial bids and the corresponding maximum bids; and
providing at least one trained user to enter each of the initial bids and the corresponding maximum bids from each of the forms into one of the devices.

12. The method of claim 1 further accepting an auction spending limit from each of the participants.

13. The method of claim 1 wherein the server can close a first item or group of items at a different time than a second item or group of items.

14. A method for automating an auction comprising the steps of:
providing a secure server configured to manage the auction;
providing at least one device to accept at least one input from a plurality of participants, wherein the input includes personal information;
assigning each of the plurality of participants a unique participant identifier;
accepting at least one initial bid and a corresponding maximum bid from each of a plurality of participants wherein each of the initial and the corresponding maximum bids is assigned to an item in the auction;
directly updating the participants of a bid status of the item; and
determining a winning bidder for each of the items in the auction based on the initial and the corresponding maximum bids assigned to the item.

15. The method of claim 14 wherein the unique participant identifier is at least one of an identification number and a barcode.

16. The method of claim 14 further comprising automatically charging the winning bidder based on the providing step.

17. An apparatus for automating an auction comprising:
a secure server configured to manage the auction;
at least one device to accept bidding information from at least one of a plurality of participants; and
software wherein the software accepts an initial bid and a corresponding maximum bid on at least one item, wherein the software stores each of the initial and the corresponding maximum bids on each of the items in the auction, wherein the software updates the participants regarding a bid status corresponding to the item, and wherein the software determines a winning bidder of the item in the auction based on the initial and the corresponding maximum bids assigned to the item.

18. The apparatus of claim 17 further comprising at least one of a group including a projection system that displays the bid status, and means to directly notify a participant that bid on the item of the bid status.

19. The apparatus of claim 18 wherein the projection system displays at least one of a group including: a list of the most active bids, a list of the most recent bids, a list of the current bids, a list of the winning bids, a description of each of the items, a scrolling display of the active bids, a recognition of at least one of the donors of the items, and a recognition of at least one of the sponsors of the event.

20. The apparatus of claim 17 wherein the device consists of at least one of a group including a computer and a portable digital device.
